(19) United States
(12) Patent Application Publication
(10) Pub. No.: US 2026/0235111 A1
(43) Pub. Date: Aug. 13, 2026

(54) METHODS FOR RETROFITTING WIND TURBINE BLADES ON WIND TURBINES

(71) Applicant: VESTAS WIND SYSTEMS A/S, Aarhus N (DK)

(72) Inventors: Peter FYNBO, Risskov (DK); Thomas S. Bjertrup NIELSEN, Skødstrup (DK); Torben Ladegaard BAUN, Skødstrup (DK); Søren STEFFENSEN, Brabrand (DK); Peter BØTTCHER, Egå (DK)

(21) Appl. No.: 19/157,608

(22) PCT Filed: Feb. 26, 2024
(86) PCT No.: PCT/DK2024/050036

§ 371 Date: Aug. 18, 2025

(30) Foreign Application Priority Data
Feb. 24, 2023 (DK) PA202370106

(51) Int. Cl. F03D 80/50

(52) U.S. Cl. CPC F03D 80/507; F03D 80/502; F05B 2230/61; F05B 2230/80

(57) ABSTRACT

A method of retrofitting wind turbine blades (26a, 26b, 26c) on a wind turbine (10) is disclosed. The wind turbine blades (26a, 26b, 26c) each include a plurality of sections. An inner blade section (36a, 36b, 36c) is coupled to the rotor hub (24). An outer blade section (38a, 38b, 38c) is coupled to the inner blade section (36a, 36b, 36c) at an interface bracket (34a, 34b, 34c). A blade (26a, 26b, 26c) is selected. For the selected blade (26a, 26b, 26c), the method includes (i) coupling a lifting tool (42, 62, 72) to the interface bracket (34a, 34b, 34c). The lifting tool (42, 62, 72) includes a hoist (50) and a lifting cable (52, 66, 88) operatively coupled to the hoist (50). The method further includes (ii) coupling the lifting cable (52, 66, 88) to the outer blade section (38a, 38b, 38c), iii) disconnecting the outer blade section (38a, 38b, 38c) from the inner blade section (36a, 36b, 36c) so that the inner blade section (36a, 36b, 36c) remains coupled to the rotor hub (24) and the outer blade section (38a, 38b, 38c) is supported by the lifting tool (42, 62, 72), and iv) using the lifting tool (42, 62, 72), lowering the outer blade section (38a, 38b, 38c) to a support surface adjacent the wind turbine (10).

### TECHNICAL FIELD

The invention relates generally to wind turbines, and more particularly to methods of retrofitting blades on a wind turbine.

### BACKGROUND

Wind turbines are used to produce electrical energy using a renewable resource and without combusting a fossil fuel. A wind turbine converts kinetic wind energy into mechanical energy and then subsequently converts the mechanical energy into electrical energy. A common type of wind turbine is the single rotor upwind horizontal-axis wind turbine (HAWT). An exemplary single-rotor HAWT includes a tower, a nacelle located at the apex of the tower, and a single rotor having a central hub and one or more blades (e.g., three blades) mounted to the hub and extending radially therefrom. The rotor is supported by the nacelle and positioned at the front of the nacelle so that the rotor faces into the wind upstream of its supporting tower. The rotor may be coupled either directly or indirectly with a generator housed inside the nacelle and configured to convert the mechanical rotation of the rotor to electrical energy.

Wind turbine manufacturers continually strive to design and manufacture wind turbines with improved power production. The design of the wind turbine plays a significant role in the generated power output from wind. For example, energy obtained from the wind is proportional to the sweep area of the wind turbine blades. For single-rotor HAWTs, the sweep area may be increased by using longer wind turbine blades. The longer the blades, the larger the area that is traced by the blade tips. This translates to more energy extraction from the wind. However, the length, maximum chord length and root diameter of a wind turbine blade for a particular wind turbine is limited by several design factors.

As an exemplary limit, blade weight and root diameter increase with blade length. Each of these physical characteristics pose significant design challenges. For one, reliably supporting an increasingly heavier wind turbine blade at its attachment point at the rotor becomes a limiting factor. The increased loading at the root magnifies fatigue at this location during rotation of the rotor and during yaw motion of the rotor when the wind turbine is operational. Transportation of the blades from a manufacturing location to site installation is a known challenge and increasing blade length, root diameter, and weight make transportation more challenging.

One design solution that permits increased blade length is to support the wind turbine blades during wind turbine operation with cables. Cable supported blades may be relatively longer than a blade without cable support. Wind turbines utilizing rotors that are supported by cabling may be referred to as a “cable-supported rotor” or “cable-stayed rotor.” Specifically, a webbing of cables extends to and between adjacent blades. With the aid of cables, the blades are capable of being proportionally longer while addressing the design problems identified above. In this way, cable supported rotors may be utilized to increase the sweep area of the blades to produce more energy from the wind. Longer blades may be assemblies of multiple parts or lengthwise sections. Where a blade is constructed of two lengthwise sections, the blade is often referred to as a “two-part blade” or “split blade.” The overall length of a split blade may include the sum of lengths of a main or inner blade section and a tip or outer blade section.

During operation of the wind turbine, the blades sustain damage over time. The damage eventually requires that the blades be replaced from time to time to maintain efficient power generation. One technique to replace blades is to use a crane to lift the blades from the central hub and then lift a new blade into position on the central hub. The height of the wind turbine tower and the weight and size of the blades require use of a specialized crane. As one exemplary characteristic, the height of a boom on the crane must be greater than the height of the wind turbine tower. Due to their specialized nature, using a crane to replace wind turbine blades is expensive. There are other blade replacement techniques, but these are also expensive and difficult to implement. For these reasons, while being necessary for long term energy efficiency, retrofitting blades remains a significant expense to operators.

Accordingly, wind turbine manufacturers and operators seek improved energy production while overcoming current design limitations including solutions to retrofitting blades at minimal cost.

### SUMMARY

To further these goals, a method of retrofitting a wind turbine is disclosed. The wind turbine is preferably a single-rotor HAWT. In one embodiment, there is a method of retrofitting a wind turbine having a plurality of wind turbine blades coupled to a rotor hub. Each of the plurality of wind turbine blades is a split blade. An inner blade section is coupled to the rotor hub, and an outer blade section is coupled to the inner blade section at an interface bracket. The method includes selecting a blade from the plurality of wind turbine blades. For the selected blade, the method further includes (i) coupling a lifting tool to the interface bracket. The lifting tool includes at least one hoist and at least one lifting cable operatively coupled to the hoist. The method further includes (ii) coupling the at least one lifting cable of the lifting tool to the outer blade section, iii) disconnecting the outer blade section from the inner blade section so that the inner blade section remains coupled to the rotor hub and the outer blade section is supported by the lifting tool, and iv) using the lifting tool, lowering the outer blade section to a support surface adjacent the wind turbine.

In one embodiment, the wind turbine includes a cable system with cable assemblies where one or more of the cable assemblies extend between adjacent blades of the plurality of wind turbine blades, and wherein the one or more cable assemblies attach to the blade at the interface bracket. In one embodiment, prior to disconnecting the outer blade section from the inner blade section, the method further includes adjusting tension in one or more of the rotor cables coupled to the blade. For example, adjusting tension in one or more rotor cables may involve increasing tension or lowering tension such as releasing tension in one or more rotor cables. This may be achieved by pitching the blades or by extending or contracting a hydraulic or electrical actuator system coupled to at least one cable of the one or more cables.

In one embodiment, the wind turbine comprises a fairing a the interface bracket. This may for example be the case if the wind turbine includes a cable system with cable assemblies, but may also be the case with other split blade designs. The method of this embodiment comprises releasing a fairing at the interface bracket from wind turbine blade prior to disconnecting the outer blade section (38a, 38b, 38c) from the inner blade section (36a, 36b, 36c). This allows for better access to the interface bracket both with regard to coupling of the lifting tool to the interface bracket and to the mechanism such as a bolted connection that secures the out blade section to the interface bracket.

In one embodiment, the lifting tool includes a first mounting bracket and a second mounting bracket. In the method, coupling the lifting tool includes coupling the first mounting bracket to the interface bracket and coupling the second mounting bracket to the outer blade section. The first mounting bracket and/or the second mounting bracket may preferably be a steel part to be bolted to the interface bracket; a swivel or lifting eye bolted to the interface bracket or to the blade; or a lifting sock/net arranged on the outer blade section.

In one embodiment, coupling the at least one lifting cable to the outer blade section includes coupling the at least one lifting cable to the second mounting bracket.

In one embodiment, the at least one lifting cable includes a pair of lifting cables, and coupling the at least one lifting cable to the outer blade section includes coupling each lifting cable of the pair of lifting cables to the second mounting bracket.

In one embodiment, the lifting tool further includes a mounting bracket connected to the outer blade section and pivotably connected to the interface bracket such that the mounting bracket and the interface bracket are rotatable relative to each other about a pivot axis.

In one embodiment, the method further includes rotating the blade to a position where the outer blade section is forced towards the interface bracket about the pivot axis by gravity prior to disconnecting the outer blade section from the interface bracket, wherein rotating the blade includes rotating the rotor hub and/or pitching the blade.

In one embodiment, prior to lowering the outer blade section to the support surface, the method further includes rotating the blade such that the outer blade section is substantially vertical.

In one embodiment, coupling the lifting tool to the blade includes coupling a crane to the interface bracket. In one embodiment, prior to disconnecting the outer blade section from the inner blade section, the method further includes rotating the blade so that the blade is substantially horizontal.

In one embodiment, subsequent to lowering the outer blade section to the support surface, the method further includes coupling the at least one lifting cable to another outer blade section, using the lifting tool, raising the another outer blade section to the inner blade section, and connecting the another outer blade section to the inner blade section.

In one embodiment, the method further comprise the step of de-coupling the lifting tool from the interface bracket. Optionally, the lifting tool may after being de-coupled from the interface bracket be moved to another interface bracket of the same wind turbine or a interface bracket of another wind turbine.

Embodiments may include selecting another of the plurality of wind turbine blades and repeating steps i)-iv) for the another blade.

In one embodiment, selecting the blade includes selecting the blade at a predetermined time based on weather associated with a specific season.

Embodiments may further include, after selecting each of the blades, after steps i)-iv) for each of the blades, and after operating the retrofitted wind turbine a first time, the method further includes: v) replacing each of the outer blade sections according to steps i)-iv) and operating the wind turbine a second time; and vi) after the second time; disconnecting the inner blade section from the rotor hub; and connecting another inner blade section to the rotor hub.

One or more of the methods of invention may allow for a low cost and easy exchangeable outer blade section exchange. The outer blade section is more prone to lightning damages and wear due to leading edge erosion. There may be a larger benefit in being able only to replace only the outer blade section instead of the entire blade for example with regard to cost and material consumption. Furthermore, the ability to only exchange the outer blade section may open up for site specific AEP optimization in form of retrofit of the outer blade section only optionally in combination with an update of the wind turbine controller.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is an elevation view of a Cable Supported Rotor wind turbine with a plurality of blades, each blade being a split-blade;

FIG. 2 is a side elevation view of the wind turbine of FIG. 1 shown without the cable system of FIG. 1 for simplicity and illustrating one embodiment of a lifting tool for retrofitting a portion of each blade;

FIG. 3 is an enlarged view of the lifting tool shown in FIG. 2 coupled to one blade;

FIGS. 4A, 4B, and 4C are side elevation views of the wind turbine of FIG. 2 illustrating use of the lifting tool for retrofitting a portion of each blade according to one embodiment;

FIGS. 5A, 5B, and 5C are elevation views of the wind turbine of FIG. 1 shown without the cable system of FIG. 1 for simplicity and illustrating use of one embodiment of a lifting tool for retrofitting a portion of each blade;

FIG. 6A is an elevation view of the wind turbine of FIG. 1 shown without the cable system of FIG. 1 for simplicity and illustrating a lifting tool coupled to a blade according to one embodiment;

FIG. 6B is an enlarged view of the lifting tool shown in FIG. 6A coupled to one blade; and

FIGS. 7A, 7B, 7C, and 7D are elevation views of the wind turbine of FIG. 6A illustrating use of the lifting tool for retrofitting a portion of each blade.

### DETAILED DESCRIPTION

With reference to figures generally, embodiments of the invention include methods for retrofitting one or more wind turbine blades on a wind turbine. Embodiments of the invention are advantageous in that blade wear/damage sustained during operation of the wind turbine is economically addressed. As an example, a lifting tool may be housed on-site at the wind turbine and is mountable to the wind turbine at an elevation at which the wind turbine blade or a portion of the blade may be disconnected from the wind turbine and replaced with a new or refurbished blade portion. A separate, ground-supported crane for disconnecting and lifting each wind turbine blade from/to the wind turbine is not needed. The expense for a separate, mobile crane is thereby avoided.

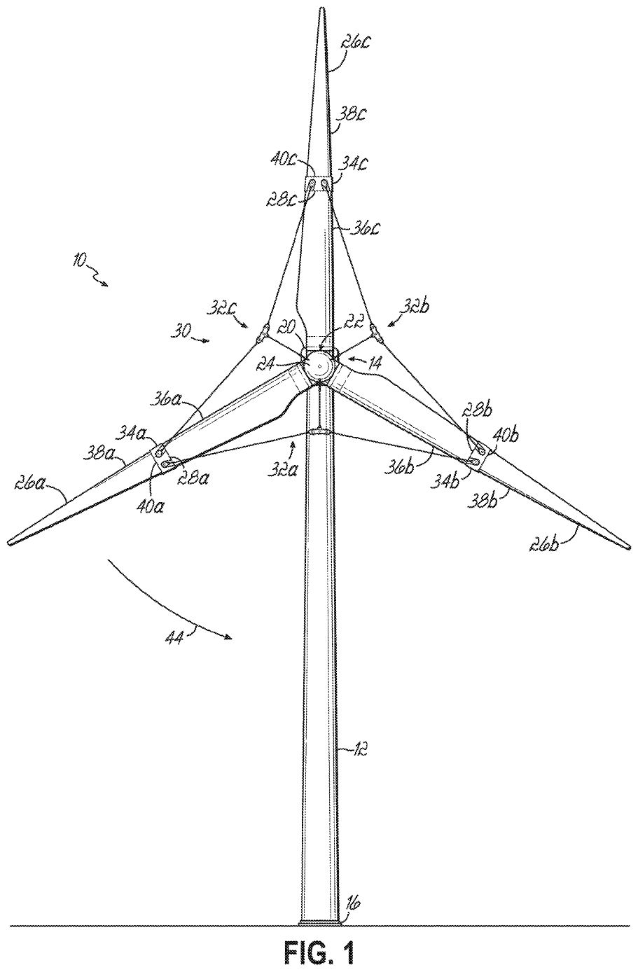

To that and other ends, an exemplary wind turbine 10 is shown in FIG. 1. The wind turbine 10 includes a tower 12 and an energy generating unit 14 (including a nacelle) disposed at the apex of the tower 12. The tower 12 may be coupled to a foundation 16 at a lower end thereof. The foundation 16 may be a relatively large mass (e.g., concrete, anchor cage, etc.) embedded in the ground and through which forces on the wind turbine 10 may be ultimately transferred. Although not shown, in an alternative embodiment, the foundation 16 may include an offshore platform or the like used in offshore wind turbine applications. The tower 12 supports the weight of the energy generating unit 14 and operates to elevate the energy generating unit 14 to a height above ground level or sea level at which faster moving air currents of lower turbulence are typically found.

In that regard, the energy generating unit 14 transforms the energy of the wind into electrical energy. The energy generating unit 14 typically includes a housing or nacelle 20, a rotor 22 having a rotor hub 24 and wind turbine blades 26a, 26b, 26c (e.g., three blades) mounted to the rotor hub 24 and extending radially therefrom. The energy generating unit 14 includes a drive train with a generator (not shown) for converting mechanical energy into electrical energy, optionally via a gear arrangement (not shown). A substantial portion of the drive train may be positioned inside of the nacelle 20 of the wind turbine 10. In addition to the generator, the nacelle 20 typically houses miscellaneous components required for converting wind energy into electrical energy and various components needed to maintain, operate, control, and optimize the performance of the wind turbine 10.

The wind turbine blades 26a, 26b, 26c are configured to interact with the wind. During operation, the wind produces lift and causes the rotor 22 to spin or rotate to generally define a sweep area of the wind turbine blades 26a, 26b, 26c. The energy generating unit 14 generates power from the wind that passes through the swept area of the rotor 22. During their interaction with the wind and weather, the wind turbine blades 26a, 26b, 26c are worn. Prolonged exposure to the weather during operation of the wind turbine 10 essentially damages the wind turbine blades 26a, 26b, 26c. After a period of operation, and to maintain operational efficiency of the wind turbine 10, the worn wind blades 26a, 26b, 26c or specific portions of each blade may be replaced as is described below.

With continued reference to the exemplary embodiment of the wind turbine 10, during operation, wind turbine blades 26a, 26b, 26c are supported by a cable system 30, which carries some of the static and dynamic loads. In essence, the cable system 30 causes the wind turbine blades 26a, 26b, 26c to mutually support each other. For example, edgewise loads and flapwise loads are shared among the wind turbine blades 26a, 26b, 26c via the cable system 30.

In FIG. 1, the exemplary cable system 30 includes three cable assemblies 32a, 32b, 32c, one cable assembly 32a, 32b, 32c, for each wind turbine blade 26a, 26b, 26c. Each cable assembly 32a, 32b, 32c is connected to the rotor 22 at three locations, one connection at the rotor hub 24 and one connection at each of two adjacent wind turbine blades 26a, 26b, 26c at a respective interface bracket 34a, 34b, 34c. That is, individual ones of the cable assemblies 32a, 32b, 32c are coupled to and between adjacent wind turbine blades 26a, 26b, 26c and to the rotor hub 24. As shown, this forms a Y-shaped cable configuration between adjacent wind turbine blades 26a, 26b, 26c and rotor hub 24.

Although not shown, tension in the cable system 30 may be adjustable via a hydraulic or electrical actuator system contained in the rotor hub 24. For example, one or more of the cable assemblies 32a, 32b, 32c may be operably coupled to a hydraulic cylinder (not shown) that extends from the rotor hub 24. Movement of the hydraulic cylinder increases or decreases tension in one or more of the cable assemblies 32a, 32b, and/or 32c. Tension in each of the assemblies 32a, 32b, 32c may be adjusted by operation of a tensioning system as is described in one or both of PCT Application Nos. PCT/DK2021/050374 and PCT/DK2022/050051. Adjusting tension in the cable assemblies 32a, 32b, and/or 32c may precede retrofitting any single one or each of the outer blade sections 38a, 38b, 38cAs another example, releasing tension in one or more cable assemblies 32a, 32b, 32c may be achieved by pitching one or more of the blades 26a, 26b, 26c about its longitudinal axis. The cable assemblies 32a, 32b and/or 32c may be released from the blade where an outer blade section is retrofitted as this allows for better access to the interface bracket. However, was found to be advantageous that the cable assemblies 32a, 32b, 32c remain connected to the interface bracket during retrofitting of outer blade section 38a, 38b, 38c, when the tension in the cable assemblies 32a, 32b, 32c is adjusted to enable the cable assemblies 32a, 32b, 32c to carry at least a part of the load of the lifting tool (42, 62, 72) during retrofitting of the outer blade section 38a, 38b, 38c. In this way, the cable assemblies 32a, 32b and/or 32c facilitate the method of present invention and hence, then method is particularly advantageous for wind turbines having cable systems with cable assemblies 32a, 32b, 32c extending between adjacent blades 26a, 26b, 26c of the plurality of wind turbine blades 26a, 26b, 26c, and wherein the one or more cable assemblies 32a, 32b, 32c attach to the blade 26a, 26b, 26c at the interface bracket 34a, 34b, 34c.

If a full blade is retrofitted, releasing tension in the cable assemblies 32a, 32b, and/or 32c and releasing the cable assemblies 32a, 32b, and/or 32c may precede retrofitting any single one or each of the blades 26a, 26b, 26c.

In the exemplary embodiment, each of the plurality of wind turbine blades 26a, 26b, 26c is a split blade. A split blade may have two or more lengthwise blade sections that are assembled end-to-end. Each blade section has a length that is less than a total length of the assembled blade. The blade sections may be manufactured separately and transported separately to a site of the wind turbine 10. When assembled end-to-end, the sections form the wind turbine blades 26a, 26b, 26c. As an example, and with reference to FIG. 1, each blade 26a, 26b, 26c may include an inner blade section and an outer blade section coupled together at the interface bracket 34a, 34b, 34c. With reference to blade 26a, for example, an inner blade section 36a is coupled to the rotor hub 24 at one end. The inner blade section 36a defines the root end of the blade 26a. The interface bracket 34a is coupled to the end of the inner blade section 36a opposite the rotor hub 24 at a first split position 28a. An outer blade section 38a is coupled to the interface bracket 34a at a second split position 40a. The outer blade section 38a defines the tip of the blade 26a.

Similarly, with reference to blade 26b, an inner blade section 36b is coupled to the rotor hub 24 at one end. The inner blade section 36b defines the root end of the blade 26b. The interface bracket 34b is coupled to the end of the inner blade section 36b opposite the rotor hub 24 at a first split position 28b. An outer blade section 38b is coupled to the interface bracket 34b at a second split position 40b. The outer blade section 38b defines the tip of the blade 26b. And, with reference to blade 26c, an inner blade section 36c is coupled to the rotor hub 24 at one end. The inner blade section 36c defines the root end of the blade 26b. The interface bracket 34c is coupled to the end of the inner blade section 36c opposite the rotor hub 24 at a first split position 28c. An outer blade section 38c is coupled to the interface bracket 34c at a second split position 40c. In other words, the inner blade section 36c is coupled to the outer blade section 38c via the interface bracket 34c. The outer blade section 38c defines the tip of the blade 26c.

As shown, the interface brackets 34a, 34b, 34c separate the inner blade sections 36a, 36b, 36c from the outer blade sections 38a, 38b, 38c. Each of the blade section 36a-36c and 38a-38c is coupled by studs (not shown) to a respective interface bracket 34a, 34b, 34c. A joint is therefore formed between the interface brackets 34a, 34b, 34c and each of the blade sections 36a-36c and 38a-38c at the first and second split positions 28a-c, 40a-c. The interface bracket 34a, 34b, 34c provides lengthwise separation between the inner blade sections 36a, 36b, 36c and the outer blade sections 38a, 38b, 38c although the blades sections 36a-36c and 38a-38c are many times longer than the interface brackets 34a, 34b, 34c. Split blades are described in detail in one or both of commonly owned PCT Application Nos. PCT/DK2021/050374 and PCT/DK2022/050051, which are incorporated by reference herein in their entireties. The connection point of the cable system 30 to each blade may be positioned outside of the wind turbine blade though at the interface bracket 34a, 34b, 34c. For example, a cable connection may extend outwardly from the interface bracket 34a, 34b, 34c and be available for connection to the cable system 30.

In view of the above, in the exemplary embodiment, each blade 26a, 26b, 26c is an assembly of three parts. For example, (i) the wind turbine blade 26a is an assembly of the inner blade section 36a, the interface bracket 34a, and the outer blade section 38a; (ii) the wind turbine blade 26b is an assembly of the inner blade section 36b, the interface bracket 34b, and the outer blade section 38b; and (iii) the wind turbine blade 26c is an assembly of the inner blade section 36c, the interface bracket 34c, and the outer blade section 38c. As shown, the cable system 30 is coupled to each of the interface brackets 34a, 34b, 34c. While FIG. 1 illustrates split blades in conjunction with the cable system 30, embodiments of the invention are not limited to cable stayed wind turbines as is shown in FIG. 1. For example, the methods disclosed herein are applicable to split blades without a cable system.

With respect to wear of the blades during operation due to weather exposure, a majority of damage to a wind turbine blade occurs on the outer one third of the blade length. Based on that and referring to the wind turbine 10 of FIG. 1, a majority of damage to each of the blades 26a, 26b, 26c occurs on the outer blade sections 38a, 38b, 38c. Therefore, in accordance with embodiments of the invention, by replacement of the outer blade sections 38a, 38b, 38c, the majority of blade damage due to operation of the wind turbine 10 can be addressed. Advantageously, only the section of the wind turbine blades 26a, 26b, 26c that sustains the bulk of the damage is replaced.

In one exemplary embodiment, the method of retrofitting wind turbine blades generally includes coupling a lifting tool to the interface bracket 34a, 34b, 34c of a selected one of the wind turbine blades 26a, 26b, 26c. It was found to be particularly advantageous to use interface bracket 34a, 34b, 34c for temporarily positioning of the lifting tool, as the interface bracket is a strong element placed between the inner blade section 36a, 36b, 36c and the outer blade section 38a, 38b, 38c and adapted to transfer the structural loads between the blade sections. Particularly, the interface bracket 34a, 34b, 34c was found to be much better suited for providing a secure and well defined connection point than the general surface of the blade. After coupling the lifting tool to the selected blade 26a, 26b, 26c, the outer blade sections 38a, 38b, 38c is disconnected from its respective interface bracket 34a, 34b, 34c. As examples, technicians may disconnect the outer blade section 38a, 38b, 38c from the interface bracket 34a, 34b, 34c via access from a man basket or with a robot. With the lifting tool in position, the disconnected outer blade section 38a, 38b, 38c is lowered toward the ground with the lifting tool. A new outer blade section is then lifted and connected to the respective interface bracket 34a, 34b, 34c by the reverse process. This may include coupling the lifting tool to the new outer blade section, raising the new outer blade section with the lifting tool, and connecting the new outer blade section to the respective interface bracket 34a, 34b, 34c. Coupling, disconnecting, lowering, and raising is preferably repeated for each wind turbine blade 26a, 26b, 26c. However, it should be observed that the method of the present invention may be used for only one wind turbine blade, i.e. to replace only one tip for example in the unlikely event that an outer blade section has been damaged by for example lightning or bird strike. A mobile, ground-supported crane is not required. Further, embodiments of the lifting tool may only need to be capable of supporting 20% of the mass of one blade 26a, 26b, 26c.

In the exemplary embodiment of the wind turbine 10 of FIG. 1, the steps of coupling, disconnecting, lowering, and raising is completed three times, once for each of the three blades. Following replacement of each of the outer blade sections 38a, 38b, 38c, the wind turbine 10 is returned to operation. Retrofitting according to embodiments of the invention may be according to a standard maintenance schedule. With the availability and cost efficiencies of embodiments of the method disclosed herein, blade portions, such as the outer blade sections 38a, 38b, 38c, may be replaced according to a schedule that is not associated with a specific damage sustained by any one of the blades 26a, 26b, 26c. In other words, the outer blade sections 38a, 38b, 38c may be replaced on a predetermined maintenance schedule for maintaining the wind turbine 10 at peak operational efficiency. However, embodiments of the invention may be utilized for emergency replacement of one or more of the outer blade sections 38a, 38b, 38c in the event of unplanned blade damage for example by bird strike, lightning or erosion of leading edge. By way of further example, the outer blade sections 38a, 38b, 38c may be exchanged according to seasonal variation in weather at the location of the wind turbine 10. For example, the outer blade sections 38a, 38b, 38c may be exchanged for a different designed outer blade sections 38a, 38b, 38c. The different designed section may be longer if a low wind season or a season with higher temperature leading to lower air density (e.g., summer in Northern Europe) is anticipated. Likewise, the different designed section may be shorter if a high precipitation season and/or cold season is anticipated or if the wind turbine 10 is operated in a Typhoon effected area.

In a exemplary embodiment the outer blade sections 38a, 38b, 38c may be designed with a different and shorter design lifetime than the inner blade sections 36a, 36b, 36c. In this way, the outer blade section may be considered a wear part with lower lifetime than the inner blade section. When designing for a lower lifetime the mass of the outer blade section can be reduced, which results in lower loads on the load carrying structure and as such lower cost. For example, the outer blade part may be designed with half the design lifetime, a third of the design lifetime or a smaller fraction of the design lifetime of the inner blade sections 36a, 36b, 36c. In this way after replacing the outer blade sections 38a, 38b, 38c the retrofitted wind turbine is operated for example two times, three times or more times. The inner blade sections 36a, 36b, 36c may also be considered a wear part where the design lifetime of the inner blade sections 36a, 36b, 36c is shorter than the design lifetime of the wind turbine. Similarly as the outer blade sections 38a, 38b, 38c may be replaced without replacing the inner blade sections 36a, 36b, 36c if the inner blade sections 36a, 36b, 36c are not worn out, then the inner blade sections 36a, 36b, 36c may be replaced if the wind turbine is not worn out when the inner blade sections 36a, 36b, 36c needs replacement. It is preferred that replacing the inner blade sections 36a, 36b, 36c are combined with replacing the outer blade sections 38a, 38b, 38c, so the full blades are replaced when the inner blade sections 36a, 36b, 36c are replaced. Since replacement of the full blade requires a full size crane, the ability to selectively replace either the outer section or both the inner section and the outer section of a blade allows for improved predicted maintenance where replacement of the outer blades may be performed as a relatively simple operation that only requires coupling of the lifting tool to the interface bracket for example by a climber or a drone. In many cases, this allows for postponing the service or replacement of the full blade to a more suitable time, for example where a crane is available for another operation nearby or when the probability of a favourable weather window is higher. The ability to replace only the outer blade section using a lifting tool without a full size crane may also allow for changing of outer blade section throughout the year. For example, in a season where strong winds are anticipated, shorter outer blade sections and/or outer blade sections with higher erosion resistance may be utilized, whereas in a season where milder winds are anticipated longer outer blade sections and/or outer blade sections with more affordable leading edge protection may be utilized. Such seasonal switching of outer blade sections may also allow for regular maintenance to be conducted on the outer blade sections not in use and hence prevent or reduce the likelihood of unscheduled maintenance of the wind turbine.

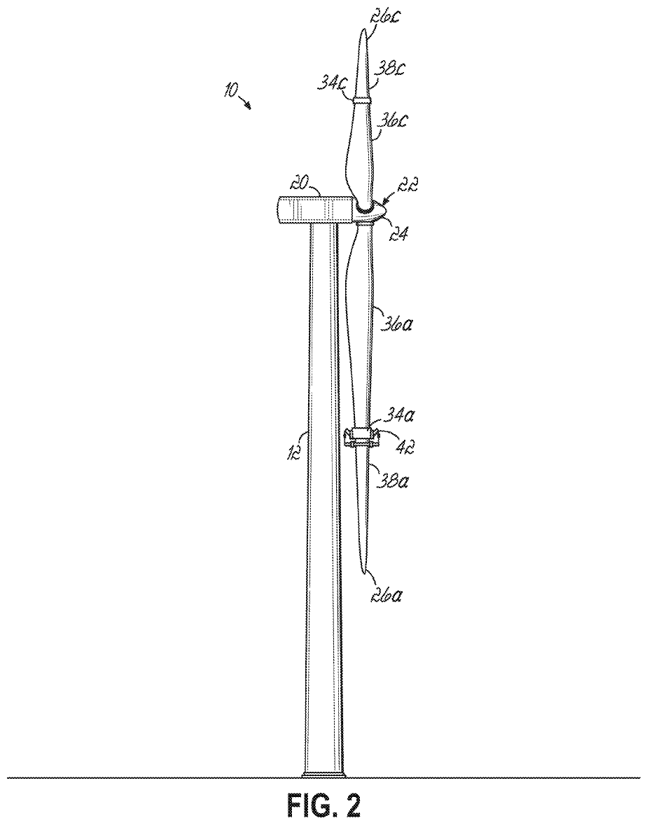

In one embodiment, and with reference to FIGS. 2, 3, 4A, 4B, and 4C, a lifting tool 42 is utilized to retrofit one or more of the blades 26a, 26b, 26c. Prior to or following coupling the lifting tool 42 to the blade 26a, the rotor 22 may be rotated from the position shown in FIG. 1 to a position shown in FIG. 2. For example, rotor 22 may be rotated counter clockwise (as indicated by arrow 44 in FIG. 1) to position the blade 26a at the 6 o'clock position, shown for example in FIG. 2. The blade 26a is shown pointed straight down or parallel to the tower 12 in FIGS. 2-4B.

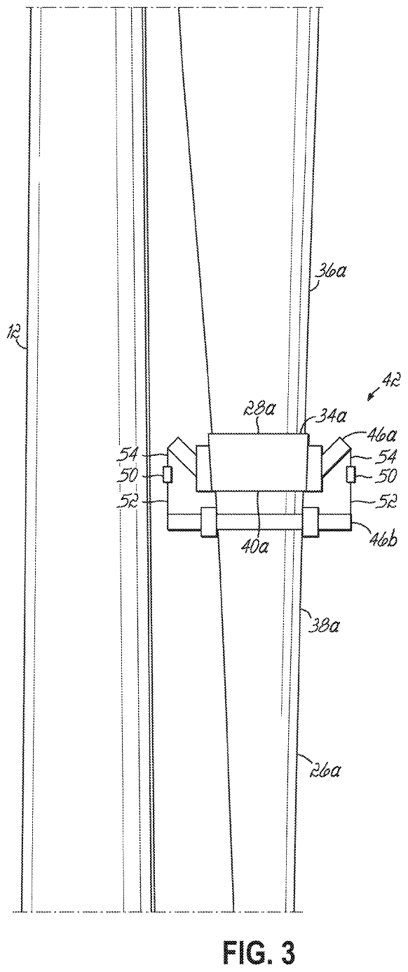

Referring to FIGS. 2 and 3, once the selected blade 26a is oriented in the 6 o'clock position, the lifting tool 42 is coupled to the blade 26a. The exemplary lifting tool 42 is shown with an upper mounting bracket 46a coupled to the interface bracket 34a, and a lower mounting bracket 46b coupled to the outer blade section 38a. As an example, the upper mounting bracket 46a may be bolted to the interface bracket 34a though other forms of attachment for example may include a steel part to be bolted to the interface bracket, a swivel or lifting eye bolted to the interface bracket or to the blade. Although not shown, the upper mounting bracket 46a may be coupled to the inner blade section 36a or a combination of the interface bracket 34a and the inner blade section 36a.

In the embodiment shown, and with reference to FIG. 3, the lifting tool 42 includes a hoist 50 and a lifting cable 52. The lifting cable 52 is operatively coupled to the hoist 50 and to the lower bracket 46b. The hoist 50 is secured to, and so hangs under gravity, from the upper bracket 46a, such as by a cable 54. The lifting cable 52 operably extends from the hoist 50 to the lower bracket 46b. As shown, a second hoist 50 may be secured to the upper bracket 46a on an opposing side of the upper bracket 46a from the first hoist 50. The second hoist 50 may therefore hang due to gravity by a cable 54 from the upper bracket 46a by a second cable 54. A second lifting cable 52 operably extends from the hoist 50 to the lower bracket 46b. The pair of hoists 50 may be operable simultaneously to maintain equal loading on each during lowering and raising of the outer blade section 38a. Embodiments of the invention are not limited to the lifting tool 42 with upper and lower brackets 46a, 46b. For example, the lifting tool 42 may include a single bracket, such as the bracket 46a, secured to the inner blade section 36a and/or the interface bracket 34a with one or more hoists 50 and cables 52 extending from the bracket to the outer blade section 38a. Instead of a single bracket, the lifting tool 42 may include one or more eye-bolts (not shown) that are secured to the interface bracket 34a. Further, in addition to or as an alternative to the lower bracket 46b, a web of straps or netting (not shown) may be used to encase or surround the outer blade section 38a to secure it during retrofitting. In other words, embodiments of the invention are not limited to the upper and lower brackets 46a, 46b shown. Although not shown, the lifting tool 42 and/or hoist 50 and cables 52 may be stored in the nacelle 20 and lowered from the nacelle 20 via an internal crane to be coupled to the blade 26a.

In one embodiment (not shown), the hoist of the lifting tool is arranged away from the interface bracket, such as for example at ground level, in the nacelle, on the nacelle, in the hub, or in the inner section of the blade, and the lifting tool includes a pulley arranged at the interface bracket for transferring the lifting cable from the hoist to the outer blade section.

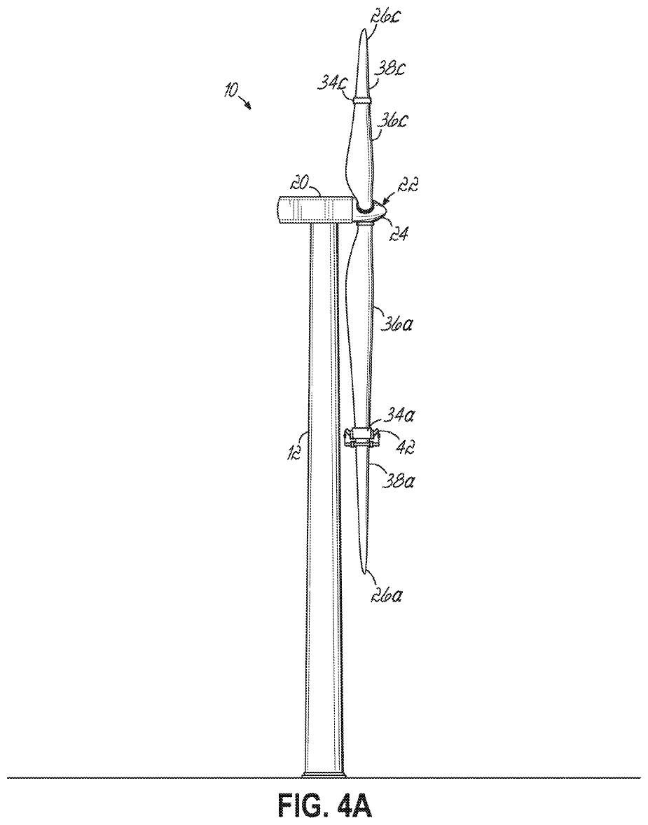

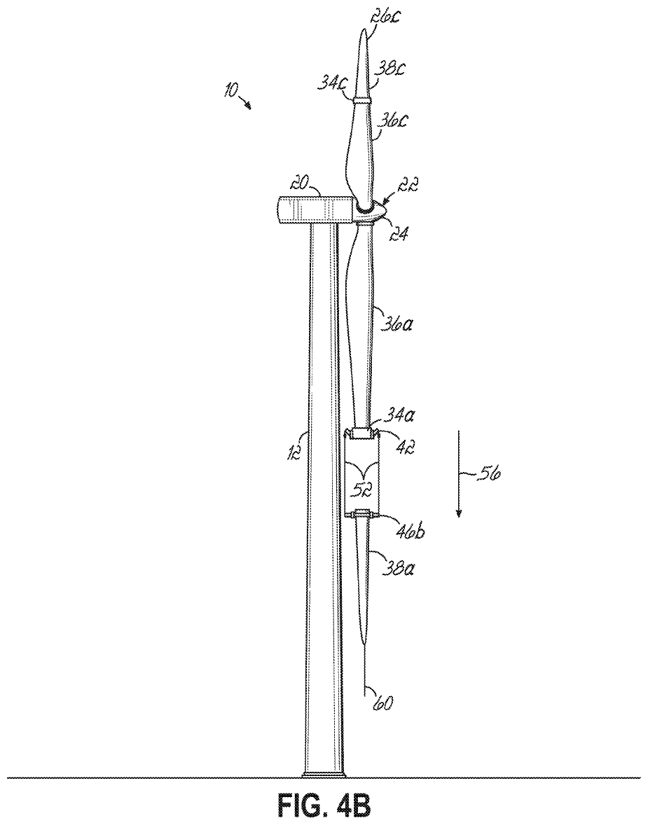

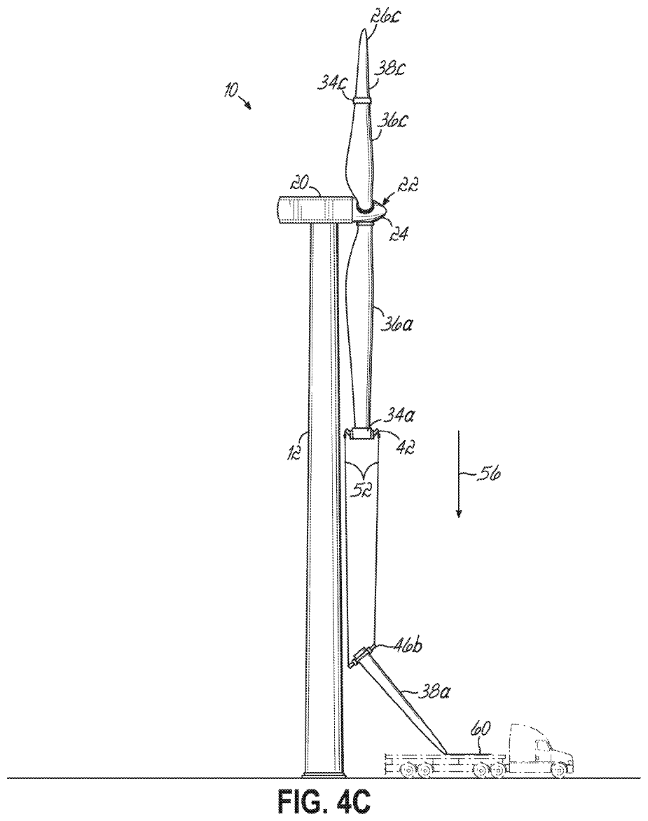

With reference to FIGS. 4A and 4B, once the lifting tool 42 is operably coupled to the blade 26a as shown in FIG. 4A, technicians disconnect the outer blade section 38a from the inner blade section 36a. For example, technicians may disconnect the outer blade section 38a at its connection (i.e., at the outer-most split position 40a) to the interface bracket 34a. In that case, the inner blade section 36a remains coupled to the rotor hub 24, and the interface bracket 34a remains coupled to the inner blade section 36a. Following disconnection of the outer blade section 38a, the weight of the outer blade section 38a is supported by the lifting tool 42. That is, the entirety of the outer blade section 38a hangs under the influence of gravity from the inner blade section 36a at the interface bracket 34a. The lifting tool 42 transfers the weight load to the rotor 22. In the exemplary embodiment shown, the outer blade section 38a is held so that it hangs with the tip down or pointed toward the earth.

As shown in FIGS. 4B and 4C by arrow 56, technicians operate the hoists 50 to lower the outer blade section 38a to a location adjacent the foundation 16 of the wind turbine 10, such as onto a transport vehicle shown in FIG. 4C. In the exemplary embodiment, a guide cable 60 is secured to a tip of the outer blade section 38a so that technicians may control the position of the section tip as operation of the hoists 50 further lower the outer blade section 38a toward the ground.

Although not shown, once the outer blade section 38a is fully lowered so there is no tension in the cables 52, the lower bracket 46b is removed from the outer blade section 38a. The lower bracket 46b may be coupled to a new or refurbished outer blade section (not shown) and the cables 52 coupled to the lower bracket 46b. Technicians may then operate the hoists 50 to raise the new or refurbished outer blade section to the interface bracket 34a. Once in an abutting position, the new or refurbished outer blade section is coupled to the interface bracket 34a. Retrofitting may continue by rotating the next blade 26b or 26c to the 6 o'clock position. Technicians may then replace the outer blades sections 38b and 38c with the lifting tool 42 in a similar manner.

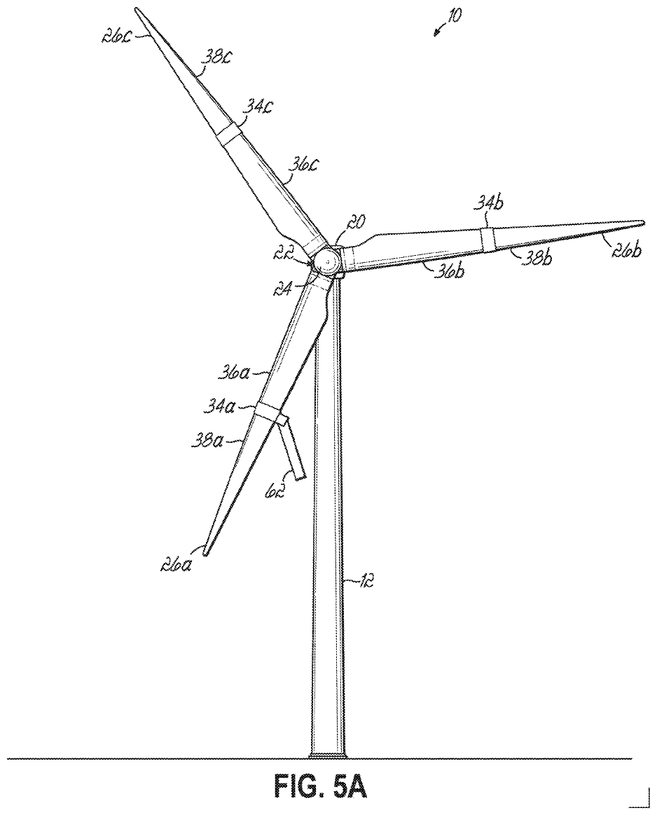

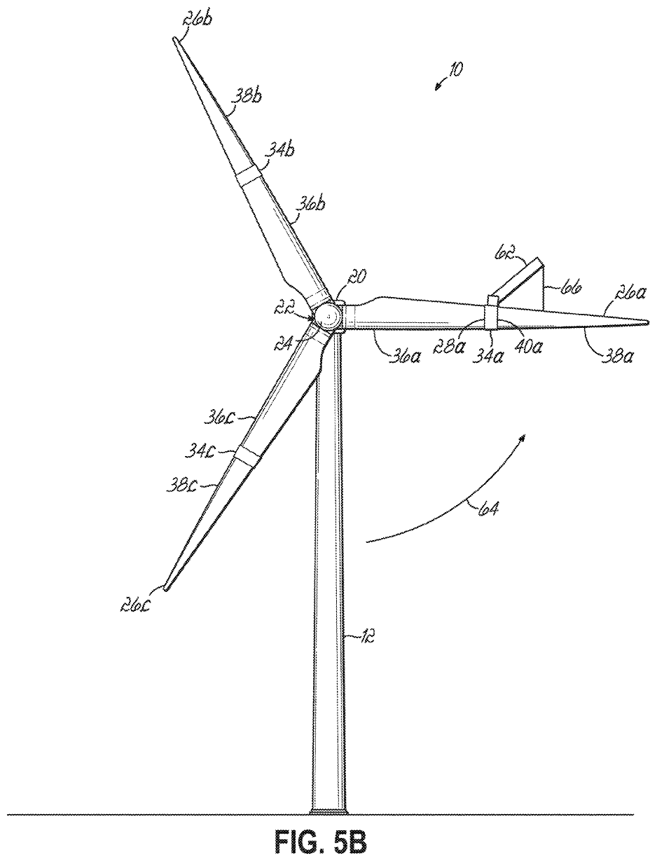

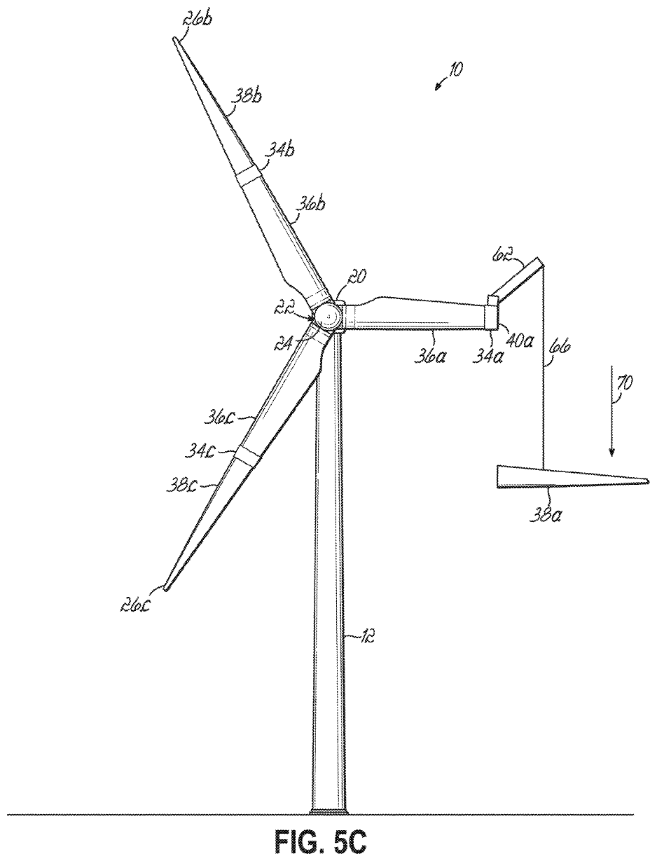

In one embodiment, and with reference now to FIGS. 5A, 5B, and 5C, a lifting tool 62 is utilized to retrofit one or more of the blades 26a, 26b, 26c. The lifting tool 62 differs from the lifting tool shown in FIGS. 2-4C. As shown, the lifting tool 62 is an auxiliary crane or similar device including a hoist and a cable operably coupled to the hoist. The lifting tool 62 may be housed in the nacelle 20 during operation of the wind turbine 10. When the blades 26a, 26b, 26c are scheduled for retrofit, the lifting tool 62 is lowered from the nacelle 20 or otherwise brought into proximity to one of the interface brackets 34a, 34b, 34c. Technicians then couple the lifting tool 62 to the interface bracket 34a, 34b, 34c. Prior to or following coupling the lifting tool 62 to the blade 26a, the rotor 22 may be rotated to a position shown in FIG. 5A to facilitate attachment of the lifting tool 62 to the interface bracket 34a. Although not shown, rotor 22 may be rotated to position the blade 26a at the 6 o'clock position prior to attachment of the lifting tool 62.

Once the lifting tool 62 is attached to the blade 26a and referring to FIG. 5B, the rotor 22 is rotated according to arrow 64 so that the blade 26a is in the 3 o'clock position. As shown, the blade 26a is horizontal (i.e., parallel with the ground) and the lifting tool 62 is oriented in a position to operate so as to bear the weight of the outer blade section 38a. A cable 66 is lowered from the auxiliary crane and is secured to the outer blade section 38a. Attachment of the cable 66 to the outer blade section 38a may be by way of straps or webbing (not shown) surrounding the outer blade section 38a and designed to hold the weight of the outer blade section 38a once it is disconnected from the interface bracket 34a.

Technicians may then disconnect the outer blade section 38a from the interface bracket 34a. The weight of the outer blade section 38a is then carried by the lifting tool 62 that is coupled to the interface bracket 34a. With reference to FIG. 5C, following disconnection from the interface bracket 34a, the outer blade section 38a hangs from the cable 66. Technicians operate the lifting tool 62 so as to extend the cable 66. This lowers the outer blade section 38a toward the ground or support surface. Lowering the outer blade section 38a is generally shown by arrow 70. As shown, in the exemplary embodiment, the outer blade section 38a is held with its longitudinal axis in a horizontal orientation, that is, the longitudinal axis is parallel with the ground. This is in contrast with a tip-down orientation shown in FIG. 4B in which the longitudinal axis of the outer blade section 38a is perpendicular to the ground. Although not shown, once the outer blade section 38a is fully lowered so that there is no tension in the cable 66, the cable 66 is disconnected from the outer blade section 38a. The lifting tool 62, via the cable 66, may be coupled to new or refurbished outer blade section (not shown). A technician may then operate the hoist of the lifting tool 62 to raise the new or refurbished outer blade section to the interface bracket 34a.

Once in an abutting position, the new or refurbished outer blade section is coupled to the interface bracket 34a. Retrofitting may continue by rotating the blade 26a to the position shown in FIG. 5A at which location the lifting tool 62 may be removed from the interface bracket 34a. Once removed, the next blade 26b or 26c is rotated into the position shown in FIG. 5A at which the lifting tool 62 may be attached to the blade 26b or 26c at the corresponding interface bracket 34b, 34c. Retrofitting may then continue as set forth above with reference to FIGS. 5B and 5C. Technicians may then replace the outer blades sections 38b and 38c with the lifting tool 62 in a similar manner.

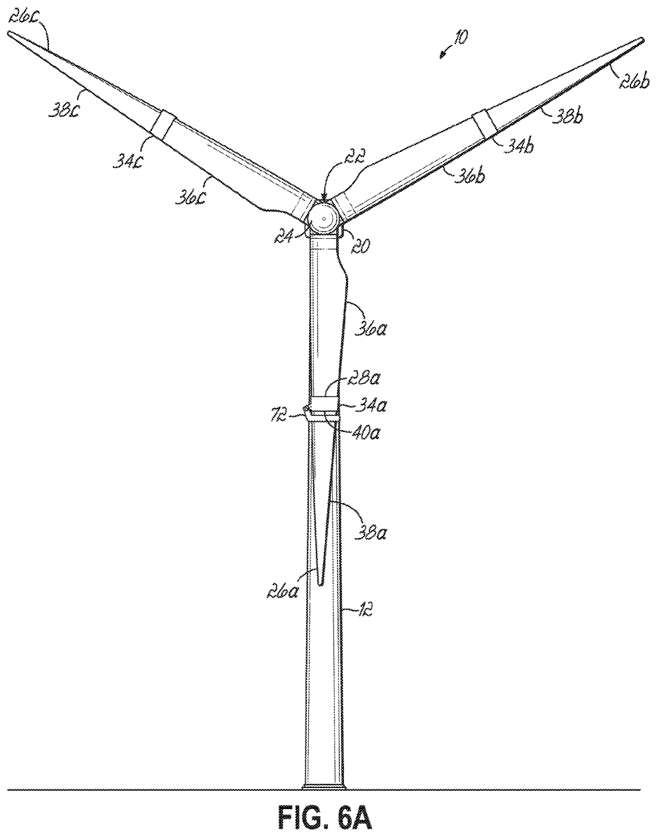

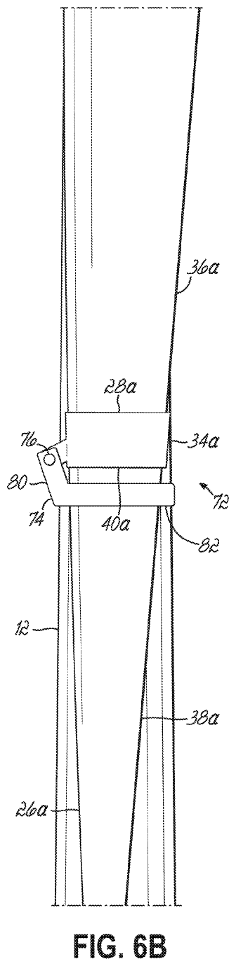

In one embodiment, and with reference now to FIGS. 6A and 6B, a lifting tool 72 is utilized to retrofit one or more of the blades 26a, 26b, 26c. The lifting tool 72 differs from the lifting tools 42 and 62 shown in FIGS. 2 and 5A, for example. As shown in FIG. 6B, the lifting tool 72 includes a mounting bracket 74 that couples the outer blade section 38a to the interface bracket 34a at a pivot axis 76. Thus, the lifting tool 72 is coupled to the interface bracket 34a on one side and is pivotable around the axis 76 on that side. The lifting tool 72 operates as a hinge about the pivot axis 76. The pivot axis 76 is spaced apart from a longitudinal axis of the blade 26a. The lifting tool 72 is also coupled to the outer blade section 38a. The mounting bracket 74 may have a dog-legged configuration. As shown, a short-legged portion 80 of the mounting bracket 74 is for connecting to the interface bracket 34a and forming the pivot axis 76. A longer-legged portion 82 extends at an obtuse angle from the short-legged portion 80 and is secured the outer blade section 38a adjacent the interface bracket 34a. The mounting bracket 74 therefore spans the outer-most split position 40a. By way of example, the longer-legged portion 82 may at least partly encircle the outer blade section 38a.

Prior to coupling the lifting tool 72 to the blade 26a, the rotor 22 may be rotated to a position shown in FIG. 6A (e.g., with the blade 26a at the 6 o'clock position) to facilitate attachment of the lifting tool 72 to the interface bracket 34a. Similar to the other lifting tools 42 and 62, the lifting tool 72 may be housed in the nacelle 20 during operation of the wind turbine 10. When the blades 26a, 26b, 26c are scheduled for replacement, the lifting tool 72 is lowered from the nacelle 20 or otherwise brought into proximity to one of the interface brackets 34a, 34b, 34c. Technicians then couple the lifting tool 72 to the interface bracket 34a, 34b, 34c at the pivot axis 76. By way of example, the pivot axis 76 may be formed on the interface bracket 34a as a connection point of one cable of the cable system 30 shown in FIG. 1. Thus, prior to coupling the lifting tool 72 to the interface bracket 34a, the cable system 30 may be disconnected from that location.

In another embodiment, the mounting bracket 74 may be permanently arranged on the outer blade section preferably with a hinged connection to the interface bracket at the pivot axis 76 thereby facilitating the coupling of the lifting tool to the interface bracket.

The connection at the pivot axis 76 may be permanently so disconnecting the outer blade section 38a requires releasing the outer blade section 38a from the mounting bracket 74. However, it is preferred that the connection at the pivot axis 76 is temporary so disconnecting the outer blade section 38a requires releasing the outer blade section 38a from the mounting bracket at the pivot axis. In one embodiment, releasing the outer blade section 38a from the mounting bracket may be achieved by removing a part forming the pivot axis, such as a bolt or a cylindrical member. In another embodiment, at least one of the mounting bracket 74 and the interface bracket 34a has a hook-like connector to the pivot axis, which allows for releasing the interface bracket 34a from the mounting bracket 74 at the pivot axis through the opening of the hook-like connector.

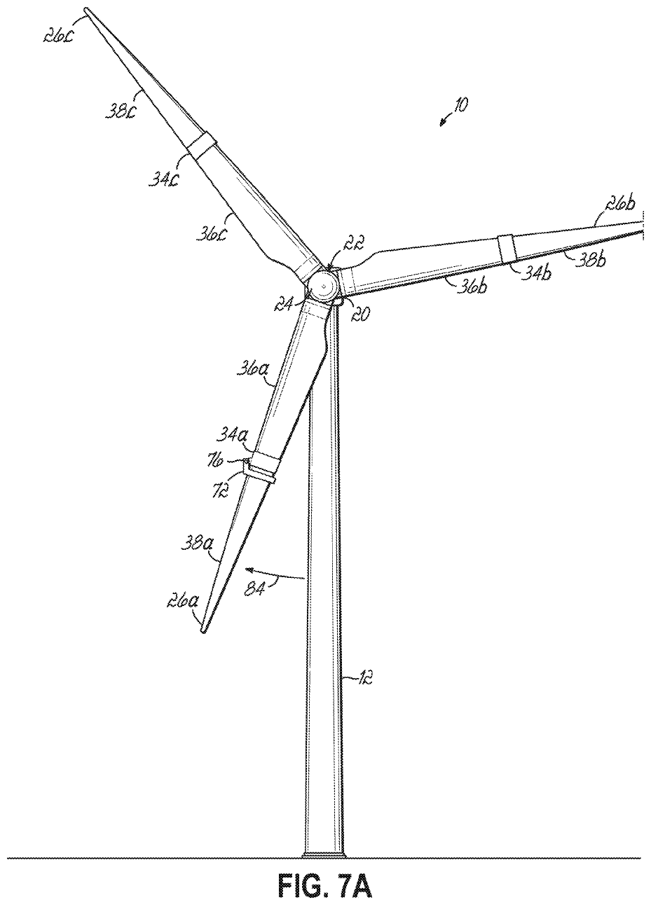

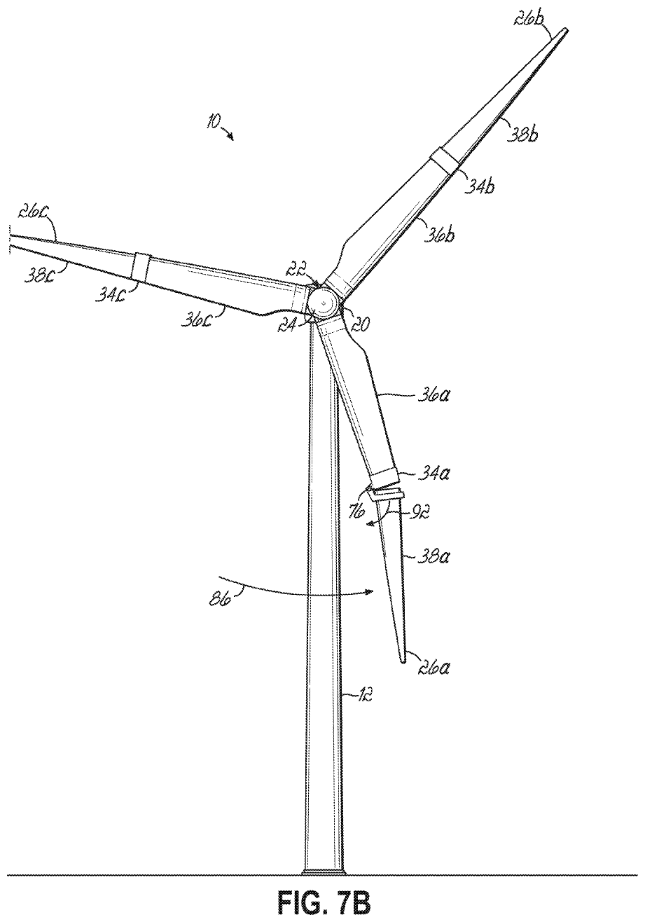

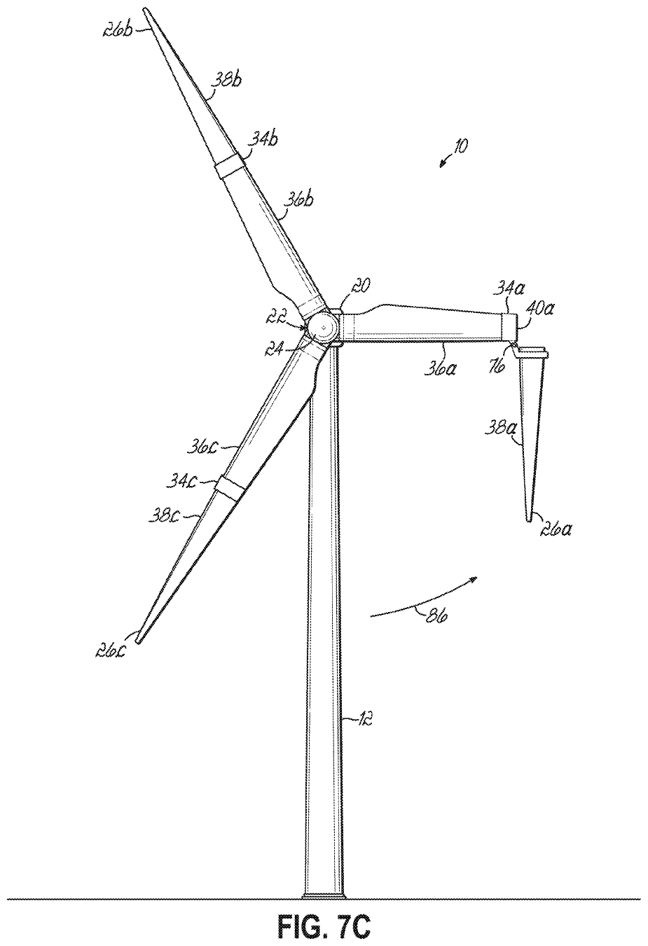

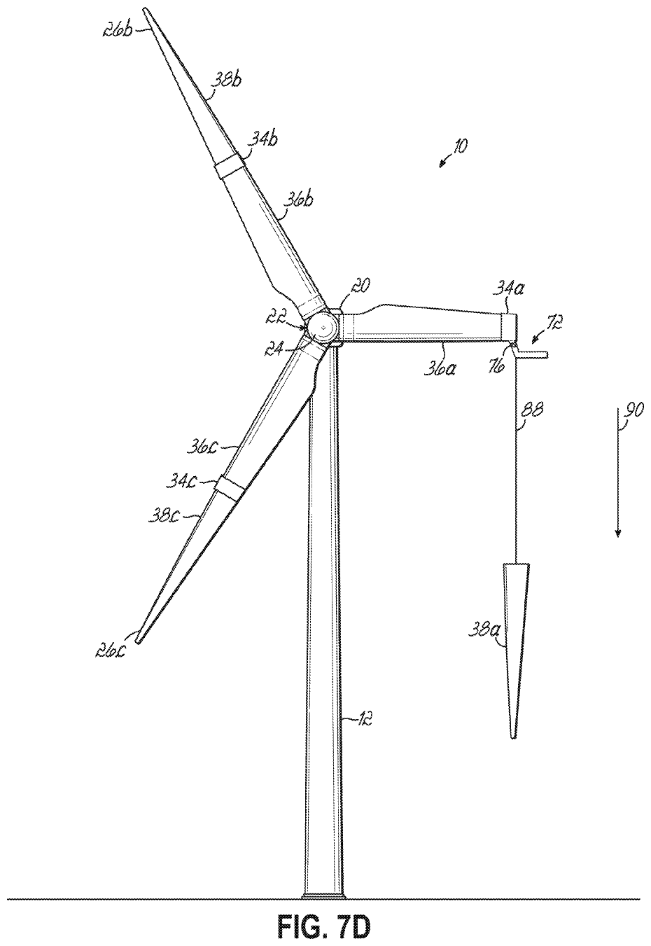

Referring to FIG. 7A, after coupling the lifting tool 72 to the interface bracket 34a and the outer blade section 38a, the rotor 22 is rotated away from the 6 o'clock position in a direction indicated by arrow 84. With this rotation, the blade 26a is brought to a position where the outer blade section 38a at the outermost split position 40a is forced towards the interface bracket 34a about the pivot axis 76 by gravity. In this position of the rotor 22, the outer blade section 38a may be carried by the pivot axis and kept towards the interface bracket 34a at the outermost split position 40a by gravity. Hence, the plurality of stucs securing the outer blade section 38a to the interface bracket 34a may be removed safely by technicians. Once disconnected from the interface bracket 34a, the outer blade section 38a is held in position and is connected to the interface bracket 34a by the lifting tool 72 at the pivot axis 76.

With reference to FIGS. 7A and 7B, the rotor 22 is rotated in a counter clockwise direction per arrow 86. At some position of the rotor 22, gravity pulls the outer blade section 38a away from the interface bracket 34a by rotating the outer blade section 38a about the pivot axis 76. The weight of the outer blade section 38a is carried at the pivot axis 76. Thus, the outer blade section 38a may tend to remain in a tip down position in which the longitudinal axis of the outer blade section 38a is generally perpendicular to the ground.

Referring to FIGS. 7B and 7C, the rotor 22 is further rotated in a counter clockwise direction according to arrow 86. With further rotation, the inner blade section 36a is brought to a 3 o'clock position. This is shown in FIG. 7C. During the rotation of the rotor 22 to the position shown in FIG. 7C, the outer blade section 38a further rotates in a clockwise direction (opposite the rotation of the rotor 22) about the pivot axis 76. This local rotation around the pivot axis 76 is shown by arrow 92 in FIG. 7B.

Once the inner blade section 36a is in the 3 o'clock position (FIG. 7C), the outer blade section 38a may be in or near a 6 o'clock position. In other words, the outer blade section 38a is generally vertically oriented with the blade tip pointed toward the ground. By way of example, the longitudinal axis of the outer blade section 38a may be oriented perpendicularly relative to the ground and to the inner blade section 36a, and may be generally parallel with the tower 12.

Referring to FIG. 7D, in one embodiment, with the inner blade section 36a at the 3 o'clock position, a cable 88 is coupled to the outer blade section 38a. For example, the cable 88 may be coupled to an end opposite the tip of the outer blade section 38a. Attachment of the cable 88 to the outer blade section 38a may be by way of straps or webbing (not shown) surrounding the outer blade section 38a and designed to hold the weight of the outer blade section 38a once it is disconnected from the interface bracket 34a. The cable 88 may be operably coupled to a hoist (not shown) that is attached to the interface bracket 34a or attached to a location on the inner blade 36a. Technicians may then disconnect the outer blade section 38a from the interface bracket 34a. The weight of the outer blade section 38a is then carried by the cable 88 that is coupled to the interface bracket 34a.

To lower the outer blade section 38a, technicians operate the lifting tool 72 to extend the cable 88. This lowers the outer blade section 38a, as is shown by arrow 90, from the interface bracket 34a toward the ground or support surface. In the exemplary embodiment shown, the mounting bracket 74 remains coupled to the interface bracket 34a during the lowering of the outer blade section 38a. In an alternative embodiment, the mounting bracket 74 is disconnected from the interface bracket 34a preferably at the pivot axis 76 and remains attached to the outer blade section 38a during lowering.

In another embodiment, the a cable 88 is coupled to the outer blade section 38a prior to the inner blade section 36a reaching the 3 o'clock position. For example, the cable 88 may be coupled prior to the rotor 22 is rotated in the counter clockwise direction and the cable 88 may carry a part of the load otherwise carried by the pivot axis 76.

Although not shown, once the outer blade section 38a is fully lowered so that no tension exists in the cable 88, the cable 88 is disconnected from the outer blade section 38a. The lifting tool 72 via the cable 88 may be coupled to a new or refurbished outer blade section (not shown). A technician may operate the hoist of the lifting tool 72 to raise the new or refurbished outer blade section to the interface bracket 34a. Once in an abutting position with the interface bracket 34a, the new or refurbished outer blade section is coupled to the mounting bracket 74 of the lifting tool 72. With the new or refurbished outer blade section coupled to the interface bracket 34a only at the pivot axis 76, the rotor 22 is rotated in a clockwise direction. This rotation causes a counter-clockwise rotation of the new or refurbished outer blade section about the pivot axis 76 of the lifting tool 72. The new or refurbished outer blade section rotates toward an abutting position with the interface bracket 34a.

Once the rotor 22 is at the position shown in FIG. 7A, the new or refurbished outer blade section abuts the interface bracket 34a. At this position, technicians secure the new or refurbished outer blade section to the interface bracket 34a with a plurality of studs. Once the blade 26a is reassembled, the lifting tool 72 is removed from the blade 26a.

Once the lifting tool 72 is removed and if another outer blade section 38b or 38c need replacement, the next blade 26b or 26c is rotated into the position shown in FIG. 6A at which the lifting tool 72 may be attached to the blade 26b or 26c. Retrofitting may then continue as set forth above with reference to FIGS. 7A-7D. Technicians may then replace the outer blades sections 38b and 38c with the lifting tool 72 in a similar manner.

According to any embodiment of the invention, during the operational life of the wind turbine 10, and possibly after multiple outer blade sections have been replaced, the inner blade sections 36a, 36b, 36c may be replaced due to cumulative damage on the inner blade sections 36a, 36b, 36c. So, while the outer blade sections 38a, 38b, 38c sustain damage at a higher rate than the inner blade sections 36a, 36b, 36c, the inner blade sections 36a, 36b, 36c are eventually also replaced. In that regard, the entire blade 26a, 26b, 26c may be replaced. This accomplishes replacement of both inner and outer blade sections and interface bracket (34a, 34b, 34c). This may also be part of a repowering or upgrade of the wind turbine where the rotor and optionally other main components of re replaced to provide the wind turbine with an upgraded configuration. For example, replacement of the inner blade sections 36a, 36b, 36c may be achieved with a crane in which the entire blade is removed and replaced. Without being bound to any schedule, the inner blade sections 36a, 36b, 36c may be replaced one time for every three outer blade sections 38a, 38b, 38c replacements. For example, the outer blade sections 38a, 38b, 38c may be replaced twice through the use of a lifting tool 42, 62, 72 and then each of the blade 26a, 26b, 26c is then replaced in its entirety.

Embodiments of the invention are exemplified with a single-rotor HAWT but are similarly useful for a multi-rotor HAWT on which the method may be used for retrofitting the wind turbine blades using the same steps and sequence as described above and thereby achieving the same advantages.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A method of retrofitting a wind turbine having a plurality of wind turbine blades coupled to a rotor hub, wherein each of the plurality of wind turbine blades is a split blade defining an inner blade section coupled to the rotor hub and an outer blade section coupled to the inner blade section at an interface bracket, the method comprising:
selecting a blade from the plurality of wind turbine blades; and
for the blade, the method further comprising:
(i) coupling a lifting tool to the interface bracket, the lifting tool comprising at least one hoist and at least one lifting cable operatively coupled to the at least one hoist;
(ii) coupling the at least one lifting cable of the lifting tool to the outer blade section;
iii) disconnecting the outer blade section from the inner blade section so that the inner blade section remains coupled to the rotor hub and the outer blade section is supported by the lifting tool; and
iv) using the lifting tool, lowering the outer blade section to a support surface adjacent the wind turbine.

2. The method of claim 1, wherein the wind turbine includes a cable system with cable assemblies where one or more of the cable assemblies extend between adjacent blades of the plurality of wind turbine blades, and wherein the one or more cable assemblies attach to the blade at the interface bracket.

3. The method of claim 2, wherein prior to disconnecting the outer blade section from the inner blade section, the method further comprises releasing a fairing at the interface bracket of wind turbine blade.

4. The method of claim 2, wherein prior to disconnecting the outer blade section from the inner blade section, the method further comprises adjusting tension in one or more of the cable assemblies coupled to the blade.

5. The method of claim 1, wherein the lifting tool includes a first mounting bracket and a second mounting bracket, and wherein coupling the lifting tool includes coupling the first mounting bracket to the interface bracket and coupling the second mounting bracket to the outer blade section.

6. The method of claim 5, wherein coupling the at least one lifting cable to the outer blade section includes coupling the at least one lifting cable (52) to the second mounting bracket.

7. The method of claim 5, wherein the at least one lifting cable includes a pair of lifting cables, and wherein coupling the at least one lifting cable to the outer blade section includes coupling each lifting cable of the pair of lifting cables to the second mounting bracket.

8. The method of claim 1, wherein the lifting tool further includes a mounting bracket connected to the outer blade section and pivotably connected to the interface bracket such that the mounting bracket and the interface bracket are rotatable relative to each other about a pivot axis.

9. The method of claim 8, further comprising rotating the blade to a position where the outer blade section is forced towards the interface bracket about the pivot axis 76 by gravity prior to disconnecting the outer blade section from the interface bracket, wherein rotating the blade includes rotating the rotor hub and/or pitching the blade.

10. The method of claim 8, wherein prior to lowering the outer blade section to the support surface, the method further comprises rotating the blade such that the outer blade section is substantially vertical.

11. The method of claim 1, wherein coupling the lifting tool to the blade includes coupling a crane to the interface bracket.

12. The method of claim 11, wherein prior to disconnecting the outer blade section from the inner blade section, the method further comprises rotating the blade so that the blade is substantially horizontal.

13. The method of claim 1, wherein subsequent to lowering the outer blade section to the support surface, the method further comprises:
coupling the at least one lifting cable to another outer blade section;
using the lifting tool, raising the another outer blade section to the inner blade section; and
connecting the another outer blade section to the inner blade section.

14. The method of claim 1, further comprising:
selecting another of the plurality of wind turbine blades; and
repeating steps i)-iv) for the another blade.

15. The method of claim 1 wherein selecting the blade includes selecting the blade regularly throughout a year based on seasonal weather.

16. The method of claim 1 wherein after selecting each of the blades, after steps i)-iv) for each of the blades, and after operating the retrofitted wind turbine a first time, the method further comprises:
v) replacing each of the outer blade sections on each of the blades according to steps i)-iv) and operating the retrofitted wind turbine a second time; and
vi) after the second time, disconnecting the inner blade section from the rotor hub; and connecting another inner blade section to the rotor hub.

17. A method of retrofitting a wind turbine having a plurality of wind turbine blades coupled to a rotor hub, wherein each of the plurality of wind turbine blades is a split blade defining an inner blade section coupled to the rotor hub and an outer blade section coupled to the inner blade section at an interface bracket; wherein the wind turbine includes a cable system with cable assemblies where one or more of the cable assemblies extend between adjacent blades of the plurality of wind turbine blades, and wherein the one or more cable assemblies attach to the blade at the interface bracket; the method comprising:
selecting a blade from the plurality of wind turbine blades; and
coupling a lifting tool, to the interface bracket of the selected blade, the lifting tool comprising at least one hoist and at least one lifting cable operatively coupled to the at least one hoist;
coupling the at least one lifting cable of the lifting tool to the outer blade section of the selected blade;
disconnecting the outer blade section from the inner blade section of the selected blade so that the inner blade section remains coupled to the rotor hub and the outer blade section is supported by the lifting tool;
using the lifting tool, lowering the outer blade section of the selected blade to a support surface adjacent the wind turbine;
prior to disconnecting the outer blade section from the inner blade section of the selected blade, releasing a fairing at the interface bracket of the selected wind turbine blade; and
prior to disconnecting the outer blade section from the inner blade section of the selected blade, adjusting tension in one or more of the cable assemblies coupled to the selected blade.

18. The method of claim 17, wherein the lifting tool includes a first mounting bracket and a second mounting bracket, and wherein coupling the lifting tool includes coupling the first mounting bracket to the interface bracket and coupling the second mounting bracket to the outer blade section.

19. The method of claim 18, wherein coupling the at least one lifting cable to the outer blade section includes coupling the at least one lifting cable to the second mounting bracket.

20. The method of claim 19, wherein the at least one lifting cable includes a pair of lifting cables, and wherein coupling the at least one lifting cable to the outer blade section includes coupling each lifting cable of the pair of lifting cables to the second mounting bracket.
